(19) United States
(12) Patent Application Publication
(10) Pub. No.: US 2017/0040855 A1
(43) Pub. Date: Feb. 9, 2017

(54) ROTOR FOR A ROTARY ELECTRIC MACHINE

(71) Applicant: MOTEURS LEROY-SOMER, Angouleme (FR)

(72) Inventor: Jacques SAINT-MICHEL, Angouleme (FR)

(73) Assignee: MOTEURS LEROY-SOMER, Angouleme (FR)

(21) Appl. No.: 15/303,432

(22) PCT Filed: Apr. 9, 2015
(86) PCT No.: PCT/IB2015/052593

§ 371 Date: Oct. 11, 2016

(30) Foreign Application Priority Data
Apr. 10, 2014 (FR) 14 53220

(51) Int. Cl. H02K 1/27; H02K 3/12

(52) U.S. Cl. CPC H02K 1/2766; H02K 3/12

(57) ABSTRACT

A rotor for a rotary electric machine has permanent magnets defining magnetic poles of the rotor, i.e. a first pole and a second pole adjacent to the first pole, the first and second poles having different polarities; permanent magnets assigned to the first pole contribute only to the polarity of the first pole, and at least one shared permanent magnet contributes in part to the polarity of the first pole and in part to the polarity of the second pole.

The present invention relates to rotary electric machines, notably synchronous motors, and more particularly to the rotors of such machines. The invention is concerned with permanent magnet rotors.

These rotors comprise a rotor mass in which permanent magnets are housed, said permanent magnets being inserted in housings that are frequently oriented radially. Also known are rotary electric machines comprising non-radial permanent magnets that are disposed for example in Vs or in Us.

By virtue of the flux concentration of the magnets in the poles, the induction obtained in the air gap is greater than the induction in the magnets. The induction obtained in the air gap may depend greatly on its circumferential position with respect to the axis of rotation.

In known rotors, in order to obtain sufficient induction levels in the air gap and to have compact machines, it may be necessary to use magnets that have a high energy density and are thus expensive. Specifically, such magnets are manufactured with rare earths.

In other machines, use is made of magnets having low energy per unit volume, which are made of ferrite, but such machines have the drawback of requiring a high polarity or rotors with a very large diameter in order to obtain levels of induction in the air gap that are comparable with what may be obtained with magnets having high energy per unit volume. A high polarity machine requires high frequencies and hence significant losses in the motor in the form of iron losses and in the inverter in the form of switching losses. Such machines having a high polarity and having magnets with a low energy density are thus used at limited speeds.

Thus, the rotors of such rotary electric machines do not make it possible to provide machines having a relatively low polarity, for example less than eight or even six, with effective use of the magnets, notably magnets made of ferrite and/or with a low energy density.

Therefore, there is a need to benefit from a rotor of a rotary electric machine that allows more effective use of the magnets, notably magnets made of ferrite and/or with a low energy density, and optionally with a polarity which is not necessarily high.

The invention aims to meet all or part of this need and achieves this, according to one of its aspects, by virtue of a rotor for a rotary electric machine, which comprises permanent magnets that define magnetic poles of the rotor, namely a first pole and a second pole adjacent to the first pole, the first and second poles having different polarities, permanent magnets inherent to the first pole contributing only to the polarity of the first pole and at least one shared permanent magnet contributing in part to the polarity of the first pole and in part to the polarity of the second pole.

The rotor comprises at least one permanent magnet shared between two consecutive poles. The term “shared permanent magnet” means a permanent magnet that is common to the definition of two consecutive poles of the rotor. This magnet may thus be disposed on an interpolar axis. At least one permanent magnet defining said first pole also defines the second pole of the rotor that is adjacent to the first pole. The limit between the two consecutive poles passes through at least one permanent magnet.

The permanent magnets may be disposed in rows, the first pole of the rotor being defined by at least one first row of inherent permanent magnets and by at least one second row of shared permanent magnets, said second row also defining, at least in part, the second pole of the rotor that is adjacent to the first pole.

In other words, the second row of permanent magnets simultaneously defines each of the two consecutive poles of the rotor between which it is situated. The shared permanent magnet belongs to the second row of permanent magnets.

The term “row” means a succession of at least two permanent magnets. A row is not necessarily linear in any case. Instead, a row may be U-shaped or V-shaped, as will be seen below.

The disposition of the magnets in rows makes it possible to obtain high saliency in each pole of the machine. The machine is thus a motor having high saliency torque, also referred to as a synchronous reluctance motor. The term “saliency of a pole” means that the reluctance varies along the pole in the air gap during the rotation of the rotor.

Moreover, in the invention, each pole may be said to be defined by a non-integer number of rows, being equal to the number of first rows plus a half; in other words, the second row defining said pole counts for half, given the use of the magnets in the second row to simultaneously define two consecutive poles of the rotor.

Thus, for a given diameter of the rotor, the number of rows per pole may be higher, such that the total quantity of permanent magnets may be greater, with equivalent bulk.

The cumulative height of the magnets in the second row common to two consecutive poles is higher, and this may make it possible to obtain an improved power factor, since a greater fraction of the voltage under load is produced by the flux of the magnets.

Moreover, the saliency ratio may be increased thereby, since the magnets shared between two consecutive poles may form a barrier to the circulation of the direct magnetic flux without affecting the magnetic flux in quadrature. Given a constant quantity of permanent magnets, the electromotive force may be greater and have fewer harmonics, since the passage of the induction through zero on the interpolar axis is more restricted angularly.

By virtue of the disposition of the magnets in the rotor mass, sufficient levels of induction are obtained in the air gap, even with relatively low polarity of the rotor, for example less than 6, with magnets having high energy per unit volume, such as magnets made of rare earths, not necessarily being used but, by contrast, magnets having low energy per unit volume, for example those made of ferrite. The cost of the rotor may thus be reduced thereby. Moreover, the polarity of the rotor may be reduced if the application so requires. Specifically, the rotor according to the invention makes it possible to increase the level of induction in the air gap without increasing the polarity and by using low energy density magnets.

The permanent magnets preferably have a rectangular shape in cross section. In a variant, the width of a magnet measured in cross section perpendicularly to the axis of rotation may narrow when facing toward the air gap. The permanent magnets may have a trapezoidal overall shape in cross section. In a further variant, the magnets may have a curved cross section, for example in the form of a ring sector.

The permanent magnets may have a width of between 4 and 20 mm. At least one magnet in a first row, or at least half the magnets in a first row, or all the magnets in a first row, may have a width greater than 4 mm, better still greater than 8 mm, or even greater than 12 mm.

The magnet or magnets in a second row of permanent magnets may be the same width as the magnets in a first row, or, in a variant, have a different width, notably a greater width. Thus, at least one shared permanent magnet may be wider in cross section than an inherent permanent magnet, being for example twice as wide as an inherent permanent magnet. Such a configuration may make it possible to minimize, or better still to eliminate, any circulation of the flux between two adjacent poles, notably direct magnetic flux, without affecting the magnetic flux in quadrature, and thus to reduce the harmonic content. The efficiency may be improved thereby. In addition, the number of material bridges, notably of radial bridges, may be reduced thereby, such that the electromagnetic torque is improved. This is because magnetic leakage in the bridges tends naturally to reduce the useful magnetic flux.

The first pole may comprise a single first row, or each of the poles of the rotor may comprise a single first row.

In a variant, said first pole may comprise at least two first rows, or each of the poles of the rotor may comprise at least two first rows, notably two, or three, or even more. In one embodiment, the first pole comprises two first rows. Each of the poles of the rotor may comprise two first rows.

The rotor may comprise a number of poles of between 2 and 12, better still between 4 and 10. The number of poles of the rotor may be less than or equal to 8, or less than or equal to 6, being for example equal to 4 or 6.

The permanent magnets may be made of ferrites or with rare earths or with any other type of magnetic material. The permanent magnets may in particular be made at least partially of ferrite. It is possible for example for them not to contain rare earths, or at the very least to contain less than 50% by mass of rare earths. The disposition of the magnets makes it possible to concentrate the flux of the magnets and to obtain advantageous performance with ferrite magnets.

In one exemplary embodiment, the permanent magnets are disposed in Us oriented toward the air gap. For one and the same pole, a row of permanent magnets thus comprises two lateral branches and a central branch. The Us of one and the same pole are disposed concentrically; in other words, the Us of one and the same pole are nested in one another. A U may have a shape that flares toward the air gap. In other words, the lateral branches of the U may be non-parallel to one another. The permanent magnets are preferably disposed in Us when each of the poles of the rotor comprises at least two first rows.

In another exemplary embodiment, the permanent magnets are disposed in Vs oriented toward the air gap. For one and the same pole, a row of permanent magnets thus comprises two lateral branches and does not have a central branch. The Vs of one and the same pole are disposed concentrically; in other words, the Vs of one and the same pole are nested in one another. The permanent magnets are preferably disposed in Vs when each of the poles of the rotor comprises a single first row.

The Us or Vs are oriented toward the air gap. The term “U or V oriented toward the air gap” means that the U or V is open in the direction of the air gap. Each lateral branch of a U or V may be formed by a single permanent magnet. In a variant, each lateral branch of a U or V is formed by more than one permanent magnet, notably by two magnets that form, for example, each branch of the U or V. Such segmentation of the magnets may make it possible to improve the circulation of the flux in the rotor mass and/or to introduce bridges so as to stiffen the latter.

A branch of a U or V may be formed of several magnets, for example two magnets. Two magnets in a branch of the U or V may be aligned. In a variant, the magnet or magnets forming a branch of a U or V may each extend along an axis, the two axes making an angle α between one another. This angle α may be between 0° and 45°.

Housings and Material Bridges

The rotor may comprise a rotor mass holding the permanent magnets, it being possible for the rotor mass to comprise housings in which the permanent magnets are disposed. A housing may have a cross section with a rectangular overall shape. In a variant or in addition, at least one housing may extend radially along a length greater than the radial length of the corresponding magnet, in cross section. The shape of the housing in cross section may be chosen so as to optimize the induction waveform in the air gap. By way of example, at least one end of the housing may have a rectangular, triangular or curved shape in cross section perpendicularly to the axis of rotation, and better still both ends have a rectangular, triangular or curved shape.

When the magnet is fitted in the corresponding housing, the part or parts of the housing without a magnet at (one of) its ends may be in the form of a right-angled triangle or curve. For two consecutive housings, the hypotenuses of the two right-angled triangle or the curve that is/are situated closest to the air gap may be disposed in a manner facing away from one another. Such a shape makes it possible to guide the magnetic flux better toward the air gap. For two consecutive housings, the hypotenuses of the two right-angled triangles or the curves that are situated closest to the axis of rotation may be disposed in a manner facing one another.

The rotor may comprise permanent magnets fitted in all or some of the housings, for example in at least half the housings, or in more than two-thirds of the housings, even better still in all the housings.

At least one housing may be configured to hold several permanent magnets in a row, or even all the permanent magnets in a row. In other words, it is possible for the rotor not to have any radial material bridges formed between two consecutive housings in a row, as explained below.

The housings may be separated by material bridges, which may extend parallel to a radial axis of the corresponding pole or be inclined with respect to the latter. The term “radial axis of the pole” means an axis of the pole that is oriented radially, that is to say along a radius of the rotor. It may be an axis of symmetry of the pole. This radial axis may intersect the apex of the pole.

The material bridges formed between the housings may extend obliquely generally along a longitudinal axis of the bridge which may form an angle having a non-zero value greater than 5°, better still greater than 10°, for example around 15°, with the radial axis of the corresponding pole of the rotor. The angle may be less than 45°, better still less than 30°, or even less than 20°.

The term “longitudinal axis of the bridge” denotes the axis disposed centrally with respect to the two short sides of the adjacent housings defining this material bridge. This axis is preferably rectilinear.

In a variant embodiment, it is possible for the rotor not to have any material bridges other than tangential material bridges. The term “tangential bridge” means a material bridge formed between a housing and the air gap. In this case, the rotor does not have radial bridges as described above. This may allow a considerable improvement in electromagnetic performance.

For one and the same pole, the housings of this pole may be disposed in a single first row. The concavity of the row may be oriented toward the apex of the pole, that is to say toward the air gap.

In a variant, for one and the same pole, the permanent magnets of this pole may be disposed in several first rows, each with a concavity that may be oriented toward the apex of the pole, notably in substantially concentric rows. The term “concentric” means that the median axes of the housings in the rows, measured in a plane perpendicular to the axis of rotation of the rotor, intersect at one and the same point. This disposition in several concentric rows makes it possible to improve the concentration of the flux without necessarily having to increase the size of the housings or the quantity of permanent magnets that are necessary to obtain an equivalent flux. The number of first rows per pole may notably be one, two, three or four.

When the rotor comprises several first rows for one and the same pole, said first rows may have a decreasing length in the direction of the air gap, the longest being closer to the axis of rotation and the shortest by the air gap. The length of a row corresponds to the cumulative length of the housings in this row.

At least two housings in two rows of one and the same pole may extend parallel to one another. All the housings in a row may extend parallel to the corresponding housings in another row.

A row may comprise a number of housings strictly greater than one, for example at least two housings, better still three housings. A row may for example comprise a central housing and two lateral housings. At least one row may comprise an odd number of housings, for example at least three housings.

Two rows of one and the same pole may have different numbers of housings. In one exemplary embodiment of the invention, at least one pole comprises a row of housings having a smaller number of housings than that in another row of this pole, for example two versus three in the other row. The row having the smaller number of housings is preferably the one closest to the air gap and farthest away from the axis of rotation.

The disposition of the housings and/or of the material bridges in a row is preferably symmetrical with respect to the radial axis of the pole.

In a row, the housings may be disposed in Vs or Us, it being possible for the Us to have a shape that flares toward the air gap. In other words, housings that constitute the lateral branches of the U may be non-parallel to one another. Thus, the inclination of the radial bridges may be opposite to that of the lateral housings, with respect to the radial axis of the pole.

When the housings in one and the same row are disposed in a U-shaped arrangement, the central housing may have a length greater or less than that of a branch of the U. In one exemplary embodiment, the branches of the U are shorter than the central branch that constitutes the base of the U.

The housings may each extend, when viewed in section in a plane perpendicular to the axis of rotation of the rotor, along a longitudinal axis which may be rectilinear or curved, preferably being rectilinear.

The housings may have a constant or variable width along their longitudinal axis, in a plane perpendicular to the axis of rotation of the rotor.

The short sides of a housing in a first row may be oriented in the direction of the radial axis of the pole with increasing distance from the axis of rotation, and converge for example substantially toward the apex of the pole.

The housings may have a rectangular or trapezoidal overall shape in cross section, that is to say perpendicularly to the axis of rotation, this list not being limiting.

The short sides of a housing may be perpendicular with respect to the long sides of the housing. The short sides of a housing may be inclined with respect to the long sides of the housing.

At least one housing may have two long sides, one of the long sides being shorter than the other. In this case, for example when the housing has a trapezoidal overall shape, the shorter of the long sides may be situated closer to the air gap than the longer of the long sides.

The short sides of a housing may be rectilinear or curved.

The material bridges between two consecutive housings in a row may have a width, measured perpendicularly to their longitudinal axis, less than 8 mm, and the material bridges may have a width greater than 0.5 mm.

Rotor Mass and Shaft

The rotor may comprise a rotor mass holding the permanent magnets and a shaft extending along an axis of rotation, on which the rotor mass is disposed. The shaft may be made of a magnetic material, advantageously making it possible to reduce the risk of saturation in the rotor mass and to improve the electromagnetic performance of the rotor. The shaft may comprise a magnetic sleeve in contact with the rotor mass, the sleeve being mounted on a magnetic or non-magnetic spindle.

In a variant, the rotor may comprise a non-magnetic shaft on which the rotor mass is disposed. The shaft may for example be made at least in part from a material from the following list, which is not limiting: steel, stainless steel, titanium or any other non-magnetic material. The rotor mass may, in one embodiment, be disposed directly on the non-magnetic shaft, for example without an intermediate rim. In a variant, notably when the shaft is not non-magnetic, the rotor may comprise a rim that surrounds the shaft of the rotor and bears against the latter.

In one variant embodiment, the second row may extend at least from the air gap to a shaft of the rotor, notably a non-magnetic shaft, the rotor not having a magnetic part between one end of the row and the shaft. In other words, the rotor does not have a radial or circumferential magnetic bridge extending between the shaft of the rotor and the second row. In this case, the second row only has two lateral branches and does not have a central branch.

The rotor mass extends along the axis of rotation and is disposed around the shaft. The shaft may comprise torque transmitting means for driving the rotor mass in rotation.

The rotor mass may be formed from a stack of magnetic lamination layers. The stack of magnetic lamination layers may comprise a stack of magnetic laminations, each in one piece, each lamination forming a layer of the stack.

A lamination may comprise a succession of sectors connected by tangential material bridges.

Each rotor lamination is for example cut out of a sheet of magnetic steel, for example steel with a thickness of 0.1 to 1.5 mm. The laminations may be coated with an electrically insulating varnish on their opposing faces before they are assembled within the stack. The insulation may also be obtained by a heat treatment of the laminations.

In a variant, the rotor mass may comprise a plurality of pole pieces assembled on the shaft of the rotor, which is preferably non-magnetic in this case. Assembly may be effected by dovetails on a shaft of the machine. Each pole piece may comprise a stack of magnetic laminations.

The distribution of the housings is advantageously regular and symmetrical, making it easier to cut out the rotor lamination and facilitating mechanical stability after cutting when the rotor mass is made up of a superposition of rotor laminations.

The number of housings and magnets depends on the polarity of the rotor. The rotor mass may comprise any number of housings, for example between 4 and 96 housings, better still between 8 and 40 housings, or even between 16 and 32 housings.

The magnets may be embedded in the rotor mass. In other words, the magnets are covered by layers of magnetic laminations at the air gap. The surface of the rotor at the air gap may be defined entirely by the edge of the layers of magnetic laminations and not by the magnets. The housings therefore do not lead radially toward the outside.

The rotor mass may comprise one or more holes in order to lighten the rotor, allow it to be balanced or to assemble the rotor laminations of which it is made up. Holes may allow the passage of tie rods that keep the laminations secured together.

The layers of laminations may be snap-fastened to one another.

The housings may be filled at least partially with a non-magnetic synthetic material. This material may lock the magnets in place in the housings and/or increase the cohesion of the set of laminations.

If necessary, the rotor mass may comprise one or more reliefs that help to position the magnets properly, notably in the radial direction.

The rotor mass may have a circular or multilobe outer contour, a multilobe shape possibly being useful for example for reducing torque undulations or current or voltage harmonics.

The rotor may or may not be mounted with an overhang.

The rotor may be made of several pieces of rotor that are aligned in the axial direction, for example three pieces. Each of the pieces may be offset angularly with respect to the other, adjacent pieces (known as a “step skew”).

Machine and Stator

A further subject of the invention is a rotary electric machine, such as a synchronous motor or a synchronous generator, comprising a rotor as defined above. The machine may be a reluctance motor. It may constitute a synchronous motor.

The machine may operate at a nominal peripheral speed (tangential speed measured at the outside diameter of the rotor) which may be greater than or equal to 100 meters per second. Thus, the machine according to the invention allows operation at high speeds, if so desired. For example, a rotor with a diameter of 100 mm may operate quite safely at 20 000 revolutions per minute.

The machine may have a relatively large size. The diameter of the rotor may be greater than 50 mm, better still greater than 80 mm, being for example between 80 and 500 mm.

The rotor may be internal or external.

The machine may also comprise a stator, which may have concentrated or distributed winding. The machine may in particular comprise a stator having distributed winding, notably when the number of poles of the rotor is less than 8. In a variant, the stator may be wound on teeth.

The stator may comprise slots for receiving the windings, said slots being closed on the air gap side, being notably open on the side away from the air gap. Moreover, the stator may comprise diamond-shaped slots, and this may make it possible to improve the filling of the slots and thus the electromagnetic performance. Finally, use may be made of wires having a flattened cross section, being in the form of a flat, so as to increase the area of copper with respect to the useful area of the slot in cross section.

The invention may be understood better from reading the following detailed description of non-limiting exemplary embodiments thereof and from studying the appended drawing, in which:

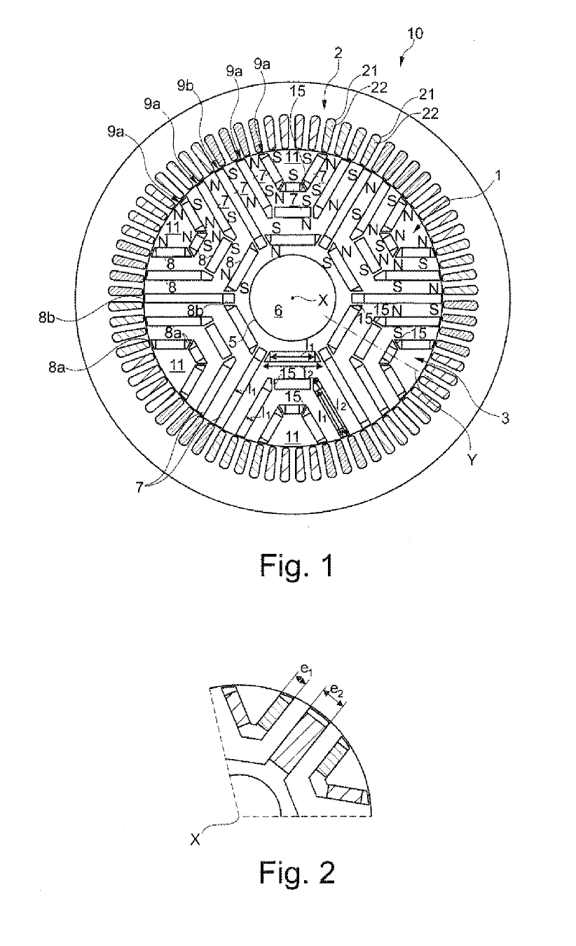

FIG. 1 schematically and partially shows a cross section through a machine comprising a rotor produced in accordance with the invention, and

FIGS. 2 to 4 are views similar to FIG. 1, illustrating variant embodiments.

FIG. 1 illustrates a rotary electric machine 10 comprising a rotor 1 and a stator 2.

The stator 2 comprises for example a distributed winding 22, as illustrated. It comprises slots 21 that are open toward the air gap, the electrical conductors of the winding 22 being disposed in said slots. This stator makes it possible to generate a rotary magnetic field for driving the rotor in rotation, within the context of a synchronous motor, and in the case of an alternator, the rotation of the rotor induces an electromotive force in the windings of the stator.

The rotor 1 shown in FIG. 1 comprises a rotor magnetic mass 3 extending axially along the axis of rotation X of the rotor, this rotor mass being formed for example by a set of magnetic laminations stacked along the axis X, the laminations being for example identical and superposed exactly. They may be held together by clip-fastening, by rivets, by tie rods, welds or any other technique. The magnetic laminations are preferably made of magnetic steel. All grades of magnetic steel may be used.

The rotor mass 3 comprises a central opening 5 for mounting it on a shaft 6. The shaft 6 may, in the example in question, be made of a non-magnetic material, for example of non-magnetic stainless steel or of aluminum, or else be magnetic.

The rotor 1 comprises a plurality of permanent magnets 7 disposed in corresponding housings 8 in the rotor magnetic mass 3. The permanent magnets 7 are disposed in rows 9a, 9b defining the six poles 11 of the rotor, namely a first pole and second pole adjacent to the first pole, the first and second poles having different polarities. The polarity of the first pole of the rotor is defined by two first rows 9a of inherent permanent magnets 7 and by a second row 9b of shared permanent magnets 7, said second row 9b likewise defining in part the polarity of the second pole of the rotor that is adjacent to the first pole. Specifically, the shared permanent magnet 7 that defines the polarity of the first pole likewise defines the polarity of the second pole of the rotor that is adjacent to the first pole. The second row 9b of permanent magnets 7 thus simultaneously defines the polarities of each of the two consecutive poles of the rotor between which it is situated. The limit between the two consecutive poles passes through at least said shared permanent magnet 7.

The permanent magnets 7 of each of the poles 11 of the rotor are disposed in Us oriented toward the air gap. For one and the same pole, a row of permanent magnets thus comprises two lateral branches and a central branch. The Us of one and the same pole are disposed concentrically; in other words, the Us of one and the same pole are nested in one another. In the example described, a U has a shape that flares toward the air gap, the lateral branches of the U not being parallel to one another.

The permanent magnets 7 have a rectangular shape in cross section. They may be made of ferrite or, alternatively, of rare earths, for example of the neodymium type or the like. Preferably, the magnets are made of ferrite.

In the example illustrated, the permanent magnets 7 of a second row 9b are the same width e₁ in cross section as the permanent magnets of a first row 9a, but if this is not the case, and if the permanent magnets 7 of a second row 9b are wider in cross section than the permanent magnets of a first row 9a, notably twice as wide, this does not represent a departure from the scope of the present invention. By way of example, FIG. 2 illustrates a variant embodiment in which the width e₂ of the permanent magnet 7 of the second row 9b is equal to twice the width e₁ of the permanent magnet 7 of the first row 9a.

Furthermore, the housings 8 extend radially along a length l₂ greater than the radial length l₁ of the corresponding magnet, in cross section. The ends 8a, 8b of the housings 8 have a rectangular or triangular shape in cross section perpendicularly to the axis of rotation. More specifically, the ends 8b of the housings belonging to a second row 9b and defining two consecutive poles 11 are rectangular. The other ends 8a generally have a triangular overall shape.

Formed between the housings are material bridges 15, which may extend parallel to a radial axis Y of the corresponding pole 11 or be inclined with respect to the latter. The term “radial axis of the pole” means an axis Y of the pole that is oriented radially, that is to say along a radius of the rotor. It is an axis of symmetry of the pole. In the example described, the material bridges 15 formed between the housings 8 of the first row 9a closest to the air gap extend obliquely toward the radial axis Y of the pole with increasing distance from the axis of rotation X. Moreover, the material bridges 15 formed between the housings 8 of the second row 9b, closest to the shaft, extend obliquely toward the radial axis Y of the pole in the direction toward the axis of rotation X. Finally, the material bridges 15 formed between the housings 8 of the first row 9a closest to the shaft 6 extend parallel to the radial axis Y of the pole.

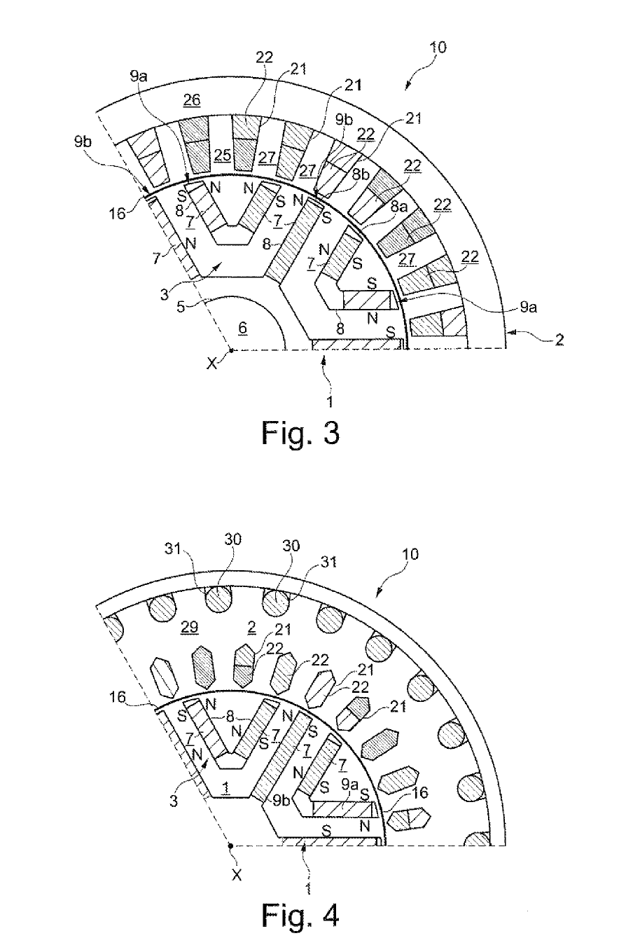

In the examples illustrated in FIGS. 3 and 4, the rotor does not have any material bridges other than tangential material bridges, and in this case does not have radial bridges 15 as described above. The rotor only comprises tangential bridges 16 formed between a housing 8 and the air gap. Moreover, each of the poles of the rotor comprises a single first row. The first row of each of the poles is disposed in a V shape in these examples, the concavity of the row being oriented toward the apex of the pole, that is to say toward the air gap.

The second row 9b extends from the air gap to a shaft 6 of the rotor 1, which is a magnetic shaft, the rotor not having a magnetic part between one end of the row and the shaft. In addition, the housings that each define the branches of one and the same V communicate via their end 8a that is closest to the axis of rotation X. Thus, the housings 8 are configured so as to hold all the permanent magnets of a row.

The embodiment illustrated in FIG. 3 also differs from the one illustrated in FIG. 1 in that the stator 2 comprises slots 21 for receiving windings, said slots being closed on the air gap side. Moreover, these slots 21 are open on the side away from the air gap. The stator 2 comprises a one-piece ring gear 25 and an attached annular yoke 26. The stator has fractionally distributed winding, comprising slots 21 formed in the ring gear 25. The slots 21 have a trapezoidal cross section and the teeth 27 separating the slots have mutually parallel edges. The slots 21 are filled from the outside. After winding, the whole is inserted into the attached annular yoke 26.

The variant embodiment illustrated in FIG. 4 differs from the one illustrated in FIG. 3 by the configuration of the stator, which comprises diamond-shaped slots 21, and this may make it possible to improve the filling of the slots 21 and thus the electrical performance. The stator in FIG. 4 also comprises a yoke 29 equipped with semicircular longitudinal ribs 31 that are intended to accommodate ducts 30 for the circulation of a cooling liquid.

In all the examples which have just been described, the rotor is on the inside, but if the rotor is on the outside, this does not represent a departure from the scope of the present invention.

Of course, the invention is not limited to the exemplary embodiments which have just been described.

The laminations may for example be produced with holes for allowing the passage of tie rods for assembling the laminations of the rotor mass.

The expression “comprising a” should be understood as being synonymous with “comprising at least one”.

1. A rotor for a rotary electric machine, which comprises permanent magnets that define magnetic poles of the rotor, namely a first pole and a second pole adjacent to the first pole, the first and second poles having different polarities, permanent magnets inherent to the first pole contributing only to the polarity of the first pole and at least one shared permanent magnet contributing in part to the polarity of the first pole and in part to the polarity of the second pole.

2. The rotor as claimed in claim 1, wherein the permanent magnets have a rectangular shape in cross section.

3. The rotor as claimed in claim 1, wherein at least one shared permanent magnet is wider in cross section than an inherent permanent magnet.

4. The rotor as claimed in claim 1, which does not have any material bridges other than tangential material bridges.

5. The rotor as claimed in claim 1, wherein the permanent magnets are disposed in rows, the first pole of the rotor being defined by at least one first row of inherent permanent magnets and by at least one second row of shared permanent magnets, said second row also defining, at least in part, the second pole of the rotor that is adjacent to the first pole.

6. The rotor as claimed in claim 5, wherein the second row extends at least from the air gap to a shaft of the rotor, the rotor not having a magnetic part between one end of the row and the shaft.

7. The rotor as claimed in claim 5, wherein said first pole comprises a single first row, or each of the poles of the rotor comprises a single first row.

8. The rotor as claimed in claim 5, wherein said first pole comprises at least two first rows, or each of the poles of the rotor comprises at least two first rows.

9. The rotor as claimed in claim 1, wherein the permanent magnets are disposed in Vs oriented toward the air gap.

10. The rotor as claimed in claim 1, wherein the permanent magnets are disposed in Us oriented toward the air gap.

11. The rotor as claimed in claim 1, which comprises a rotor mass holding the permanent magnets and a non-magnetic shaft on which the rotor mass is disposed.

12. The rotor as claimed in claim 1, which comprises a rotor mass holding the permanent magnets, the rotor mass comprising housings in which the permanent magnets are disposed, at least one housing extending radially along a length greater than the radial length of the corresponding magnet, in cross section.

13. The rotor as claimed in claim 12, wherein at least one end of the housing has a rectangular, triangular or curved shape in cross section perpendicularly to the axis of rotation.

14. The rotor as claimed in claim 12, wherein at least one housing is configured to hold several permanent magnets in a row.

15. The rotor as claimed in claim 1, which comprises a number of poles less than or equal to 8.

16. The rotor as claimed in claim 1, wherein the permanent magnets are made at least partially of ferrite.

17. A rotary electric machine comprising a rotor as claimed in claim 1, and a stator having distributed winding.

18. The machine as claimed in claim 17, wherein the stator comprises slots for receiving the windings said slots being closed on the air gap side.
